(19) United States
(12) Patent Application Publication
(10) Pub. No.: US 2025/0358244 A1
(43) Pub. Date: Nov. 20, 2025

(54) PACKET PROCESSING SYSTEM

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP); Yusuke Muranaka, Tokyo (JP)

(21) Appl. No.: 18/854,643

(22) PCT Filed: May 31, 2022
(86) PCT No.: PCT/JP2022/022092

§ 371 Date: Oct. 7, 2024

(51) Int. Cl. H04L 49/00

(52) U.S. Cl. CPC H04L 49/3009

(57) ABSTRACT

A packet processing system includes a server on which an NIC is mounted, a network switch, a processor that sets software for processing requested by a user in a compute unit of the NIC, and a flow setting circuit that sets flow information corresponding to the processing requested by the user in the NIC and the network switch. The flow setting circuit registers the flow information in a global RMT for each NIC, and registers the same content in a local RMT of an NIC that performs the processing requested by the user.

### CROSS-REFERENCE TO RELATED APPLICATIONS

This application is a national phase entry of PCT Application No. PCT/JP2022/022092, filed on May 31, 2022, which application is hereby incorporated herein by reference.

### TECHNICAL FIELD

The present invention relates to a packet processing system that realizes packet processing requested by a user.

### BACKGROUND

In recent years, a technique for implementing small-scale processing on a network interface card (NIC) has been proposed (see Non Patent Literature 1). FIG. 8 illustrates a typical implementation example.

Network ports 100-1 and 100-2 are input and output ports of a network packet. A reconfigurable match action table (RMT) 101 stores a match action table (MAT) 107. The RMT 101 reads a header of an input packet and rewrites the header of the packet with reference to the MAT 107. A switch 102 is a switch capable of switching N to N (where N is an integer of 2 or more).

Compute units 103-1 and 103-2 are small circuits or processors implemented on the NIC. A memory port 104 is an input/output port to an off-chip memory (not illustrated) on the NIC. A direct memory access (DMA) port 105 is an input/output port to a host memory of a server (not illustrated) in which the NIC is mounted. A buffer 106 is a buffer for countermeasures against back pressure.

An operation example of the RMT 101 will be described. A user determines processing and sets (deploys) software for the processing in the compute units 103-1 and 103-2. The user determines flow information. The flow information represents a path of interaction of inputting a packet via any network, memory or DMA port and outputting the packet to any network, memory or DMA port through the compute units 103-1 and 103-2.

The user registers the determined flow information in the MAT 107 as illustrated in FIG. 9. A user ID is, for example, an Internet protocol (IP) address of a user client terminal used by the user. NC is a reference sign representing a user client terminal, Comp is a reference sign representing a compute unit, and DMAPo is a reference sign representing a DMA port.

The user delivers a packet to the NIC via the network. A user ID (for example, an IP address or a port number) for uniquely identifying the user, transmission source information (an initial value is a code indicating a user client terminal), and destination information (an initial value is empty information) are stored in the header of the packet.

For example, when the network port 100-2 receives the packet from the user client terminal, the RMT 101 determines a destination of the packet on the basis of the information registered in the MAT 107, the user ID stored in the header of the packet, and the transmission source information, and writes a code indicating the determined destination in the destination information of the header of the packet. In the example in FIG. 8, the destination of the packet is determined as the compute unit 103-2. The RMT 101 transfers the packet to the switch 102.

The switch 102 selects a transfer destination such that the packet is output to the compute unit 103-2 on the basis of the destination information stored in the header of the packet transferred from the RMT 101.

The compute unit 103-2 performs processing on a payload of the packet received from the switch 102 according to preset software, and transfers the packet after the processing to the switch 102. In this case, the compute unit 103-2 rewrites the transmission source information stored in the header of the packet with a code indicating the compute unit 103-2, and rewrites the destination information stored in the header with empty information.

The switch 102 selects a transfer destination such that the packet is output to the RMT 101 on the basis of the destination information (empty information) stored in the header of the packet transferred from the compute unit 103-2.

Upon receiving the packet from the switch 102, the RMT 101 determines a destination of the packet on the basis of the information registered in the MAT 107, the user ID stored in the header of the packet, and the transmission source information, and writes a code indicating the determined destination in the destination information of the header of the packet. Here, it is determined that the destination is the DMA port 105, and a code indicating the DMA port 105 is written as destination information of the header. The RMT 101 transfers the packet to the switch 102.

The switch 102 selects a transfer destination such that the packet is output to the DMA port 105 on the basis of the destination information stored in the header of the packet transferred from the RMT 101.

In the case of an environment in which a plurality of NICs are provided as described above, the user determines desired processing, and then needs to set flow information (set the MAT) on the basis of physical information of each NIC. However, in the conventional technique, there is a problem in that, when the number of NICs increases, it is difficult to perform setting, and thus it is difficult to improve processing efficiency using a plurality of NICs.

### CITATION LIST

### Non Patent Literature

Non Patent Literature 1: Jiaxin Lin, et al., “PANIC: A High-Performance Programmable NIC for Multi-tenant Networks”, Proceedings of the 14th USENIX Symposium on Operating Systems Design and Implementation, OSDI 2020,<https://www.usenix.org/conference/osdi20/presentation/lin>

### SUMMARY

### Technical Problem

Embodiments of the present invention have been made to solve the above problems, and an object of the present invention is to provide a packet processing system capable of improving processing efficiency using a plurality of NICs.

### Solution to Problem

According to embodiments of the present invention, there is provided a packet processing system including a server on which a plurality of network interface cards are mounted; a network switch configured to transfer a packet between the server and a user client terminal; a processing setting unit configured to set software for processing requested by a user in a compute unit of a network interface card; and a flow setting unit configured to set, in the network interface card and the network switch, flow information corresponding to the processing requested by the user, in which the network switch includes a first table configured to store the flow information, and a control unit configured to determine a destination of a packet received from the server or the user client terminal on the basis of the flow information registered in the first table, and control the network switch such that the packet is transferred to the determined destination, each of the network interface cards includes the compute unit configured to perform processing on a packet according to set software, a second table configured to store the flow information, and a transfer processing unit configured to determine a destination of a received packet on the basis of the flow information registered in the second table and transfer the packet toward the determined destination, and the flow setting unit registers flow information corresponding to the processing requested by the user in the first table for each network interface card, and registers the same content as content of the flow information registered in the first table in the second table of a network interface card that performs the processing requested by the user.

### Advantageous Effects

According to embodiments of the present invention, the processing setting unit sets the software for the processing requested by the user in the compute unit of the network interface card, and the flow setting unit registers the flow information corresponding to the processing requested by the user in the first table for each network interface card, and registers the same content as that of the flow information registered in the first table in the second table of the network interface card that performs the processing requested by the user, whereby it is possible to improve the processing efficiency by using the plurality of network interface cards without the user knowing information of a physical device.

### BRIEF DESCRIPTION OF THE DRAWINGS

FIG. 1 is a block diagram illustrating a configuration of a packet processing system according to a first embodiment of the present invention.

FIG. 2 is a diagram illustrating an example of information registered in a global RMT in the first embodiment of the present invention.

FIG. 3 is a diagram illustrating an example of information registered in a local RMT of a network interface card according to the first embodiment of the present invention.

FIG. 4 is a diagram illustrating an example of information registered in a local RMT of the network interface card according to the first embodiment of the present invention.

FIG. 5 is a block diagram illustrating a configuration of a packet processing system according to a second embodiment of the present invention.

FIG. 6 is a block diagram illustrating a configuration of a packet processing system according to a third embodiment of the present invention.

FIG. 7 is a block diagram illustrating a configuration example of a computer that implements the packet processing systems according to the first to third embodiments of the present invention.

FIG. 8 is a block diagram illustrating a configuration of a conventional network interface card.

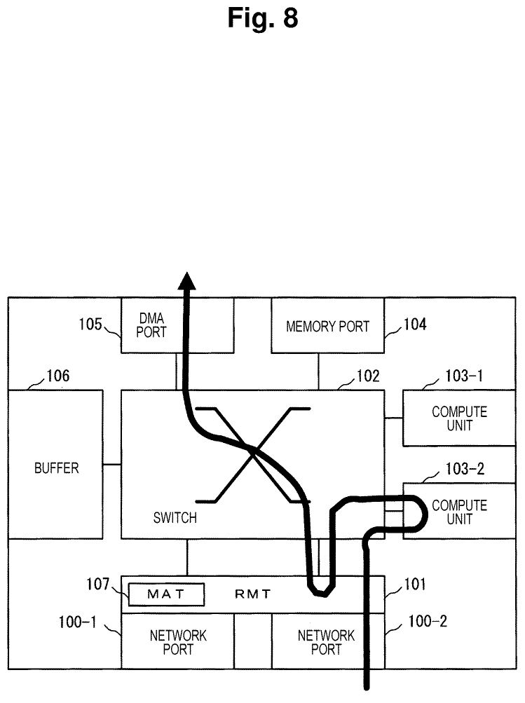

FIG. 9 is a diagram illustrating an example of information registered in an MAT in the conventional network interface card.

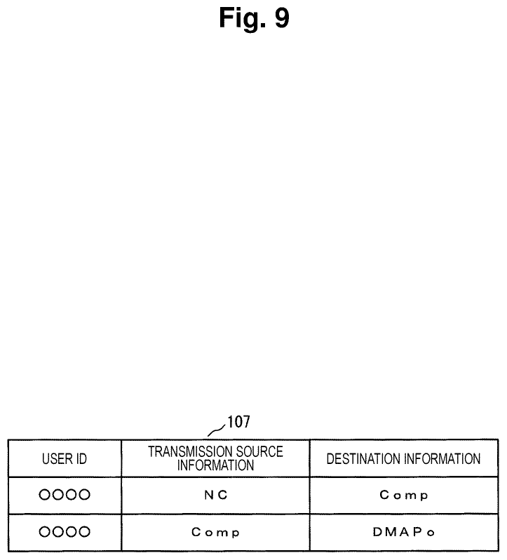

### DETAILED DESCRIPTION OF ILLUSTRATIVE EMBODIMENTS

### First Embodiment

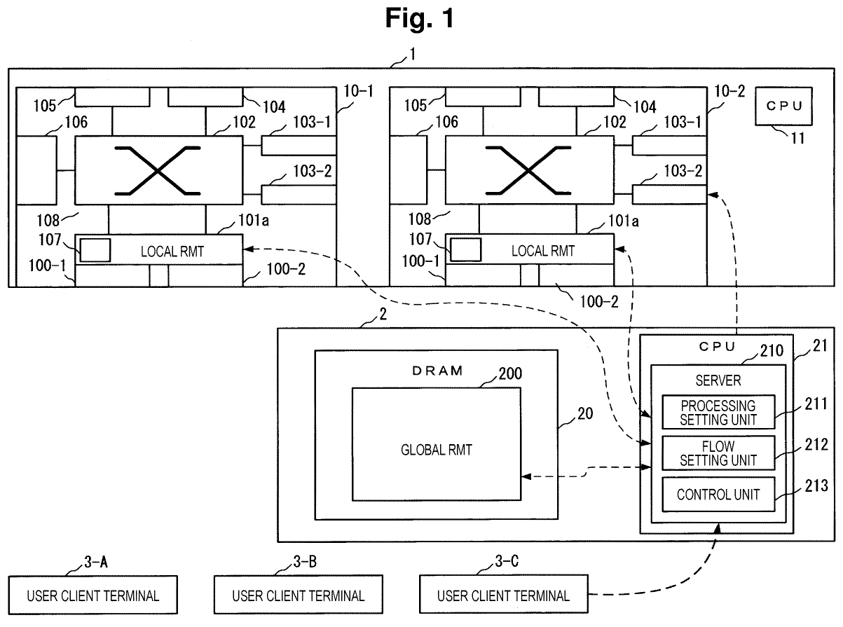

Hereinafter, embodiments of the present invention will be described with reference to the drawings. FIG. 1 is a block diagram illustrating a configuration of a packet processing system according to a first embodiment of the present invention. The packet processing system includes a server 1 that is a device on which a plurality of network interface cards (NICs) are mounted, a network switch 2, and user client terminals 3-A to 3-C.

Each of the NICs 10-1 and 10-2 mounted on the server 1 includes network ports 100-1 and 100-2, a local RMT 101a, a switch 102, compute units 103-1 and 103-2, a memory port 104, a DMA port 105, and a buffer 106. The local RMT 101a and the switch 102 configure a transfer processing unit 108 of the NIC.

The network switch 2 includes a dynamic random access memory (DRAM) 20 and a central processing unit (CPU) 21.

The CPU 21 functions as the server 210 according to a preset program. The server 210 functions as a processing setting unit 211, a flow setting unit 212, and a control unit 213.

A user requests the server 210 to set desired processing via a user client terminal, and registers flow information indicating a packet path in the global RMT 200 (first table) of the network switch 2.

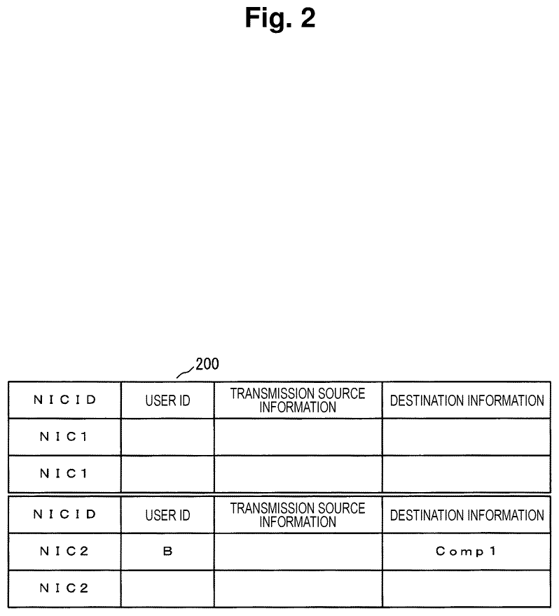

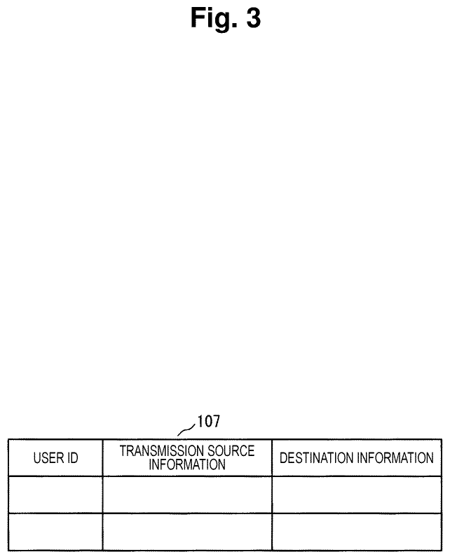

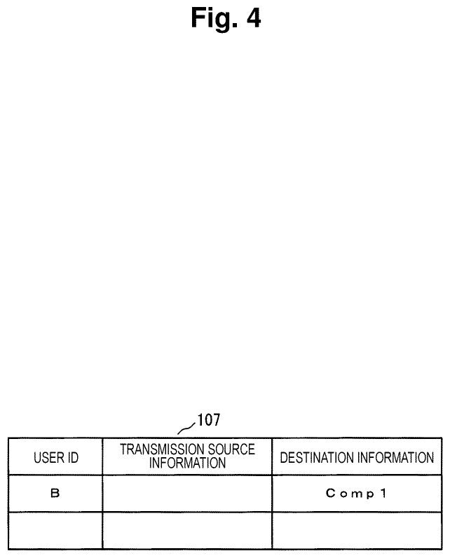

The global RMT 200 is stored in the DRAM 20 of the network switch 2. The DRAM 20 may be referred to by the CPU 21. FIG. 2 illustrates an example of information registered in the global RMT 200, FIG. 3 illustrates an example of information registered in the MAT 107 of the local RMT 101a of the NIC 10-1, and FIG. 4 illustrates an example of information registered in the MAT 107 of the local RMT 101a of the NIC 10-2.

A user ID for uniquely identifying a user, transmission source information, and destination information are registered in the MAT 107 (second table) of the local RMT 101a of the NIC 10-1. Similarly, a user ID, transmission source information, and destination information are registered in the MAT 107 (second table) of the local RMT 101a of the NIC 10-2. B in FIGS. 2 and 4 is an ID of a user B who uses the user client terminal 3-B. Comp1 is a reference sign indicating the compute unit 103-1.

In the global RMT 200, an NIC ID for uniquely identifying an NIC, a user ID, transmission source information, and destination information are registered. As described above, the global RMT 200 is obtained by aggregating the flow information registered in the local RMT 101a of each of the NICs 10-1 and 10-2. That is, the flow information (a user ID, transmission source information, and destination information) is registered in the global RMT 200 for each NIC. NIC1 and NIC2 in FIG. 2 are IDs of the NIC 10-1 and the NIC 10-2.

When the network switch 2 receives a packet, the server 210 refers to the global RMT 200 and transfers the received packet to an appropriate NIC.

Hereinafter, a configuration and an operation of the packet processing system of the present embodiment will be described in more detail. Here, a situation in which the user B of the user client terminal 3-B uses the NIC 10-2 first is considered. It is assumed that flow information for the user B to use the compute unit 103-1 of the NIC 10-2 is registered in the MAT 107 of the local RMT 101a of the NIC 10-2 as illustrated in FIG. 4. Therefore, the same flow information is registered in the global RMT 200 together with the ID of the NIC 10-2.

It is assumed that a user C using the user client terminal 3-C wants to execute a flow using two compute units. The user C requests the server 210 to set processing of the two compute units via the user client terminal 3-C.

The processing setting unit 211 of the server 210 that has received a request from the user C sets software for the processing requested by the user C in the NICs 10-1 and 10-2. In this case, there are a plurality of types of setting (deployment) policies. For example, in order to maximize processing performance, it is preferable to select the compute units 103-1 and 103-2 of the NIC 10-1. From the viewpoint of efficient use of resources, it is preferable to select a partially used NIC while avoiding selection of an unused NIC. The setting policies are stored in the server 210 in advance.

Here, it is assumed that the processing setting unit 211 selects the compute units 103-1 and 103-2 of the NIC 10-1 and sets software for the processing requested by the user C. Specifically, the processing setting unit 211 transmits the software for the processing requested by the user C to the CPU 11 of the server 1 on which the NICs 10-1 and 10-2 are mounted, and requests the compute units 103-1 and 103-2 of the NIC 10-1 to set the software. The CPU 11 having received the request from the processing setting unit 211 via the NIC 10-1 or 10-2 sets the software in the compute units 103-1 and 103-2 of the NIC 10-1.

After the setting is completed, the flow setting unit 212 of the server 210 registers flow information corresponding to the processing requested by the user C in the global RMT 200. The flow setting unit 212 registers the same content as that of the flow information registered in the global RMT 200 in the local RMT 101a of an NIC indicated by the NIC ID added to the flow information.

Specifically, the flow setting unit 212 transmits the NIC ID and the flow information to the CPU 11 of the server 1 on which the NICs 10-1 and 10-2 are mounted, and requests the CPU 11 to register the flow information. The CPU 11 having received the request from the flow setting unit 212 via the NIC 10-1 or 10-2 passes the flow information to the local RMT 101a of the NIC 10-1 indicated by the NIC ID. The local RMT 101a of the NIC 10-1 that has received the flow information registers the flow information in the MAT 107 stored therein.

The flow setting unit 212 periodically updates the flow information registered in the local RMT 101a such that the flow information registered in the global RMT 200 and the flow information registered in the local RMTs 101a of the NICs 10-1 an 10-2 have the same content.

Specifically, the flow setting unit 212 transmits the NIC ID and the flow information read from the global RMT 200 to the CPU 11 of the server 1, and requests the CPU 11 to update the flow information. The CPU 11 having received the request from the flow setting unit 212 via the NIC 10-1 or 10-2 passes the flow information to the local RMT 101a of an NIC indicated by the NIC ID. The local RMT 101a updates the flow information registered in the MAT 107 stored therein to the flow information received from the CPU 11.

The user client terminal 3-C transmits a packet that the user C desires to process to the network. The control unit 213 of the network switch 2 determines a destination of the packet on the basis of the flow information registered in the global RMT 200, the user ID stored in the header of the packet received from the user client terminal 3-C, and the transmission source information.

Here, the control unit 213 determines the destination of the packet as the NIC 10-1, and writes a code indicating the NIC 10-1 as destination information of the header of the packet. The control unit 213 controls the network switch 2 such that the packet received from the user client terminal 3-C is transferred to the NIC 10-1.

When the network port 100-1 or 100-2 receives the packet from the user client terminal 3-C, the local RMT 101a of the NIC 10-1 determines a destination of the packet on the basis of the flow information registered in the own MAT 107, the user ID stored in the header of the packet, and the transmission source information.

The local RMT 101a of the NIC 10-1 determines the destination of the packet as, for example, the compute unit 103-1, and writes a code indicating the compute unit 103-1 as destination information of the header of the packet. The RMT 101a transfers the packet to the switch 102.

The switch 102 of the NIC 10-1 selects the transfer destination such that the packet is output to the compute unit 103-1 on the basis of the destination information stored in the header of the packet transferred from the RMT 101a.

The compute unit 103-1 of the NIC 10-1 performs processing on the payload of the packet received from the switch 102 according to preset software, and transfers the packet after the processing to the switch 102. In this case, the compute unit 103-1 rewrites the transmission source information stored in the header of the packet with a code indicating the compute unit 103-1, and further rewrites the destination information stored in the header with empty information.

The switch 102 of the NIC 10-1 selects a transfer destination such that the packet is output to the RMT 101a on the basis of the destination information (empty information) stored in the header of the packet transferred from the compute unit 103-1.

Upon receiving the packet from the switch 102, the RMT 101a of the NIC 10-1 determines a destination of the packet on the basis of the information registered in the own MAT 107, the user ID stored in the header of the packet, and the transmission source information. The RMT 101a determines the destination of the packet as the DMA port 105, and writes a code indicating the DMA port 105 as destination information of the header of the packet. The RMT 101a transfers the packet to the switch 102.

The switch 102 of the NIC 10-1 selects a transfer destination such that the packet is output to the DMA port 105 on the basis of the destination information stored in the header of the packet transferred from the RMT 101a.

The CPU 11 of the server 1 performs processing on the packet transferred from the DMA port 105 of the NIC 10-1 to the host memory (not illustrated) of the server 1 as necessary, and transfers the packet after the processing to the NIC 10-1. In this case, the CPU 11 rewrites the transmission source information stored in the header of the packet with a code indicating the CPU 11, and further rewrites the destination information stored in the header with empty information or a code indicating the RMT 101a.

The switch 102 of the NIC 10-1 selects a transfer destination such that the packet is output to the RMT 101a on the basis of the destination information stored in the header of the packet transferred from the CPU 11 via the DMA port 105.

Upon receiving the packet from the switch 102, the RMT 101a of the NIC 10-1 determines a destination of the packet on the basis of the information registered in the own MAT 107, the user ID stored in the header of the packet, and the transmission source information. Here, the RMT 101a determines the destination of the packet as the network switch 2.

The RMT 101a of the NIC 10-1 rewrites the transmission source information stored in the header of the packet with a code indicating the NIC 10-1, and further rewrites the destination information stored in the header with a code indicating the network switch 2. RMT 101a transfers the packet to the network port 100-1 or 100-2.

The control unit 213 of the network switch 2 determines a destination of the packet on the basis of the flow information registered in the global RMT 200, the user ID stored in the header of the packet received from the NIC 10-1, and the transmission source information. The control unit 213 determines the destination of the packet as the user client terminal 3-C, and writes a code indicating the user client terminal 3-C as destination information of the header of the packet.

The control unit 213 controls the network switch 2 such that the packet received from the NIC 10-1 is transferred to the user client terminal 3-C. As described above, the packet after the processing is transferred from the server 1 to the user client terminal 3-C via the network switch 2.

After completion of the processing, the CPU 11 of the server 1 transmits the ID of the user C to the NIC 10-1, and instructs the local RMT 101a of the NIC 10-1 to delete the flow information used for processing the packet. The local RMT 101a of the NIC 10-1 that has received the instruction deletes the flow information including the received user ID from the MAT 107 stored therein.

After completion of the deletion, the CPU 11 of the server 1 transmits the ID of the NIC 10-1 and the flow information read from the local RMT 101a of the NIC 10-1 to the flow setting unit 212 of the network switch 2 such that the flow information registered in the local RMT 101a of the NIC 10-1 and the flow information registered in the global RMT 200 have the same content, and requests the flow setting unit 212 to update the flow information of the global RMT 200.

Upon receiving the request from the CPU 11, the flow setting unit 212 updates the flow information of the global RMT 200 corresponding to the NIC ID received from the CPU 11 to the flow information received from the CPU 11.

According to the present embodiment, a user can be provided with services by using the packet processing system without knowing information of a physical device. In the present embodiment, the processing setting unit 211 and the flow setting unit 212 can maximize the performance or the utilization efficiency of the packet processing system.

### Second Embodiment

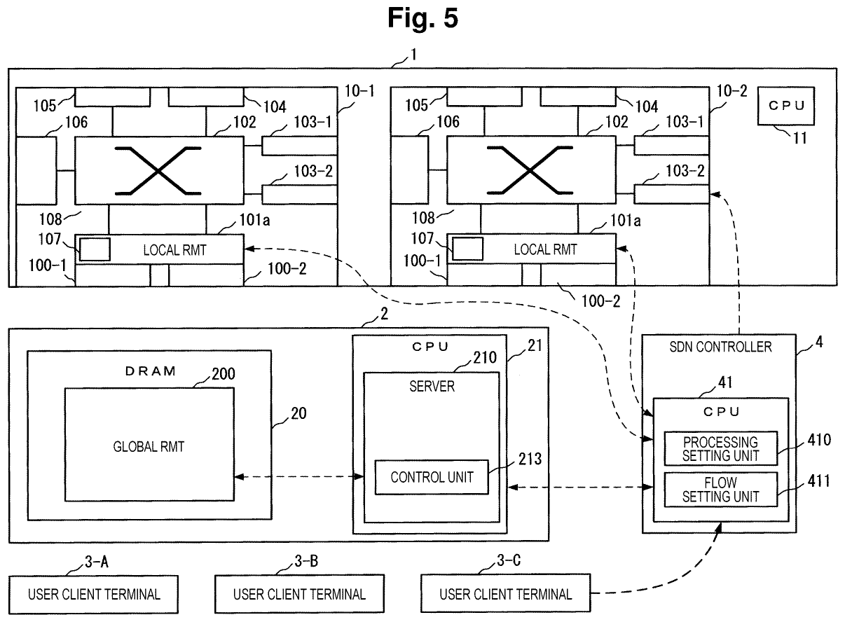

Next, a second embodiment of the present invention will be described. FIG. 5 is a block diagram illustrating a configuration of a packet processing system according to a second embodiment of the present invention. The packet processing system of the present embodiment includes a server 1, a network switch 2, user client terminals 3-A to 3-C, and a software defined network (SDN) controller 4.

The SDN controller 4 includes a CPU 41. The CPU 41 functions as a processing setting unit 410 and a flow setting unit 411.

In the present embodiment, the processing setting unit and the flow setting unit described in the first embodiment are mounted on the SDN controller 4.

The processing setting unit 410 realizes a function equivalent to that of the processing setting unit 211 of the first embodiment, and sets software for processing requested by a user in the NIC 10-1 or 10-2 by using an application programming interface (API).

The flow setting unit 411 realizes a function equivalent to that of the flow setting unit 212 of the first embodiment, and performs an operation on the local RMT 101a of the global RMT 200, the NIC 10-1, and the NIC 10-2 by using the API.

In the present embodiment, resources can be scheduled from the SDN controller 4 existing in the related art, and user convenience can be improved.

### Third Embodiment

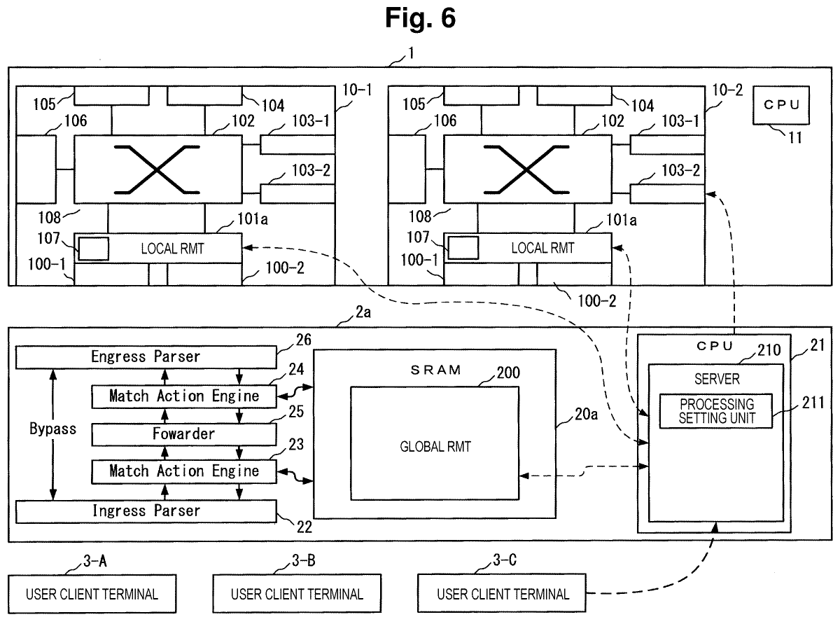

Next, a third embodiment of the present invention will be described. FIG. 6 is a block diagram illustrating a configuration of a packet processing system according to a third embodiment of the present invention. The packet processing system of the present embodiment includes a server 1, a network switch 2a, and user client terminals 3-A to 3-C.

The network switch 2a includes a static random access memory (SRAM) 20a, a CPU 21, an ingress parser 22, match action engines 23 and 24, a fowarder 25, and an engress parser 26.

The network switch 2a of the present embodiment realizes the functions of the flow setting unit 212 and the control unit 213 described in the first embodiment by using hardware. The hardware may be an application specific integrated circuit (ASIC) or a field-programmable gate array (FPGA).

The ingress parser 22 separates a packet having a header including a user ID and a packet not having such a header, and delivers the packet having the header including the user ID to the match action engine 23. The ingress parser 22 refers to the global RMT 200 and transfers packets returned from the NIC 10-1 and 10-2 to an appropriate user client terminal.

The match action engines 23 and 24 refer to the global RMT 200 from the input header information, and rewrites the header of the packet.

The fowarder 25 outputs the output of the match action engine 23 or 24 to an appropriate switch port.

The engress parser 26 delivers the output of the global RMT 200 to the appropriate NIC 10-1 or 10-2. The engress parser 26 delivers, to the network switch 2a, a packet that requires reference to the global RMT 200 among packets returned from the NIC 10-1 and 10-2.

Thus, in the present embodiment, the functions of the flow setting unit 212 and the control unit 213 described in the first embodiment can be realized by the ingress parser 22, the match action engines 23 and 24, the fowarder 25, and the engress parser 26 by using hardware. In the present embodiment, by referring to the global RMT 200 by using hardware, it is possible to improve throughput, latency, and power efficiency.

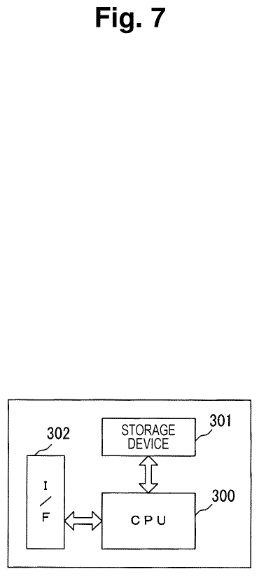

Each of the server 1, the network switches 2 and 2a, the user client terminals 3-A to 3-C, and the SDN controller 4 described in the first to third embodiments can be realized by a computer including a CPU, a storage device, and an interface, and a program for controlling these hardware resources. A configuration example of this computer is illustrated in FIG. 7.

The computer includes a CPU 300, a storage device 301, and an interface device (I/F)

302. In such a computer, a program for realizing the method of the present invention is stored in the storage device 301. The CPU 300 of each device executes the processing described in the first to third embodiments according to the program stored in the storage device 301.

At least a part of the server 1, the network switches 2 and 2a, the user client terminals 3-A to 3-C, and the SDN controller 4 may be configured by an FPGA or an ASIC.

Some or all of the above embodiments may be described as the following supplementary notes, but are not limited to the following.

(Supplementary Note 1) A packet processing system according to the present invention includes: a server on which a plurality of network interface cards are mounted; a network switch configured to transfer a packet between the server and a user client terminal; a processing setting unit configured to set software for processing requested by a user in a compute unit of a network interface card; and a flow setting unit configured to set flow information corresponding to the processing requested by the user in the network interface card and the network switch, in which the network switch includes a first table configured to store the flow information and a control unit configured to determine a destination of a packet received from the server or the user client terminal on the basis of the flow information registered in the first table and control the network switch such that the packet is transferred to the determined destination, each of the network interface cards includes the compute unit configured to perform processing on the packet according to set software, a second table configured to store the flow information, and a transfer processing unit configured to determine a destination of a received packet on the basis of the flow information registered in the second table and transfer the packet toward the determined destination, and the flow setting unit registers, for each network interface card, flow information corresponding to the processing requested by the user in the first table, and registers the same content as content of the flow information registered in the first table in the second table of a network interface card that performs the processing requested by the user.

(Supplementary Note 2) In the packet processing system according to Supplementary Note 1, the processing setting unit selects a compute unit of a network interface card for the processing requested by the user according to a predetermined setting policy, and sets software for the processing requested by the user in the selected compute unit of the network interface card.

(Supplementary Note 3) In the packet processing system according to Supplementary Note 1, the transfer processing unit determines a destination of the packet on the basis of the flow information registered in the second table, and rewrites destination information stored in a header of the packet such that the packet is transferred toward the determined destination.

(Supplementary Note 4) In the packet processing system according to Supplementary Note 1, the control unit determines a destination of the packet on the basis of the flow information registered in the first table, and rewrites destination information stored in a header of the packet such that the packet is transferred toward the determined destination.

(Supplementary Note 5) In the packet processing system according to Supplementary Note 1, the compute unit rewrites transmission source information stored in a header of the packet with information indicating the compute unit after performing processing on the received packet.

(Supplementary Note 6) In the packet processing system according to any one of Supplementary Notes 1 to 5, the processing setting unit and the flow setting unit are provided in the network switch.

(Supplementary Note 7) In the packet processing system according to any one of Supplementary Notes 1 to 5, the processing setting unit and the flow setting unit are provided in an SDN controller.

(Supplementary Note 8) In the packet processing system according to any one of Supplementary Notes 1 to 5, the flow setting unit is provided in the network switch, and the flow setting unit and the control unit are configured by hardware.

### INDUSTRIAL APPLICABILITY

Embodiments of the present invention can be applied to a technique of performing processing on a packet by using an NIC.

### REFERENCE SIGNS LIST

1 Server

2,2a Network switch

3-A to 3-C User client terminal

4 SDN controller

10-1, 10-2 Network interface card

11, 21, 41 CPU

20 DRAM

20a SRAM

22 Ingress Parser

23, 24 Match action engine

25 Fowarder

26 Engress Parser

100-1, 100-2 Network port

101a Local RMT

102 Switch

103-1, 103-2 Compute unit

104 Memory port

105 DMA port

106 Buffer

107 MAT

108 Transfer processing unit

1-8. (canceled)

9. A packet processing system comprising:
a server on which a plurality of network interface cards is mounted;
a network switch configured to transfer a packet between the server and a user client terminal;
a processor configured to set software for processing requested by a user in a first compute unit of a first network interface card of the plurality of network interface cards; and
a flow setting circuit configured to set, in the first network interface card and the network switch, flow information corresponding to the processing requested by the user,
wherein the network switch includes:
a first table configured to store the flow information, and
a controller configured to determine a destination of the packet based on the flow information registered in the first table, and cause the packet to be transferred to the destination of the packet,
wherein each of the network interface cards includes:
a compute unit configured to perform processing on a received packet according to set software,
a second table configured to store flow information corresponding to the received packet, and
a transfer processor configured to determine a destination of the received packet based the flow information registered in the second table and transfer the received packet toward the destination of the received packet, and
wherein the flow setting circuit is configured to register flow information corresponding to the processing requested by the user in the first table for each of the plurality of network interface cards, and register a same content as content of the flow information registered in the first table in the second table of the first network interface card that performs the processing requested by the user.

10. The packet processing system according to claim 9, wherein the processor is further configured to:
select the first compute unit of the first network interface card for the processing requested by the user according to a predetermined setting policy; and
set software for the processing requested by the user in the first compute unit of the first network interface card.

11. The packet processing system according to claim 9, wherein the transfer processor is configured to:
determine the destination of the received packet based on the flow information registered in the second table; and
rewrite destination information stored in a header of the received packet such that the received packet is transferred toward the determined destination.

12. The packet processing system according to claim 9, wherein the controller is configured to:
determine the destination of the packet based on the flow information registered in the first table; and
rewrite destination information stored in a header of the packet such that the packet is transferred toward the determined destination.

13. The packet processing system according to claim 9, wherein the first compute unit is configured to rewrite transmission source information stored in a header of the packet with information indicating the first compute unit after performing processing on the packet.

14. The packet processing system according to claim 9, wherein
the processor and the flow setting circuit are provided in the network switch.

15. The packet processing system according claim 9, wherein
the processor and the flow setting circuit are provided in an SDN controller.

16. The packet processing system according to claim 9, wherein
the flow setting circuit is provided in the network switch, and
the flow setting circuit and the controller are configured by hardware.

17. A packet processing system comprising:
a server on which a plurality of network interface cards is mounted;
a network switch configured to transfer a packet between the server and a user client terminal;
a processor configured to set software for processing requested by a user in a first compute unit of a first network interface card of the plurality of network interface cards; and
a flow setting circuit configured to set, in the first network interface card and the network switch, flow information corresponding to the processing requested by the user,
wherein the network switch includes a first table configured to store the flow information,
wherein the first network interface card includes:
a compute unit configured to perform processing on the packet according to set software,
a second table configured to store the flow information, and
wherein the flow setting circuit is configured to register a same content as content of the flow information registered in the first table in the second table of the first network interface card that performs the processing requested by the user.

18. The packet processing system according to claim 17, wherein the processor is further configured to:
select the first compute unit of the first network interface card for the processing requested by the user according to a predetermined setting policy; and
set software for the processing requested by the user in the first compute unit of the first network interface card.

19. The packet processing system according to claim 17, wherein the first network interface card further includes a transfer processor configured to:
determine a destination of the packet based on the flow information registered in the second table; and
rewrite destination information stored in a header of the packet such that the packet is transferred toward the determined destination.

20. The packet processing system according to claim 17, wherein the network switch comprises a controller configured to:
determine a destination of the packet based on the flow information registered in the first table; and
rewrite destination information stored in a header of the packet such that the packet is transferred toward the determined destination.

21. The packet processing system according to claim 20, wherein
the flow setting circuit is provided in the network switch, and
the flow setting circuit and the controller are configured by hardware.

22. The packet processing system according to claim 17, wherein the first compute unit is configured to rewrite transmission source information stored in a header of the packet with information indicating the first compute unit after performing processing on the packet.

23. The packet processing system according to claim 17, wherein
the processor and the flow setting circuit are provided in the network switch.

24. The packet processing system according claim 17, wherein
the processor and the flow setting circuit are provided in an SDN controller.
